(19) United States
(12) Patent Application Publication
(10) Pub. No.: US 2009/0089792 A1
(43) Pub. Date: Apr. 2, 2009

(54) METHOD AND SYSTEM FOR MANAGING THERMAL ASYMMETRIES IN A MULTI-CORE PROCESSOR

(75) Inventors: Darrin P. Johnson, San Jose, CA (US); Eric C. Saxe, Livermore, CA (US); Bart Smaalders, Menlo Park, CA (US)

Correspondence Address: OSHA LIANG L.L.P./SUN, TWO HOUSTON CENTER, 909 FANNIN, SUITE 3500, HOUSTON, TX, 77010, US

(73) Assignee: SUN MICROSYSTEMS, INC., Santa Clara, CA (US)

(21) Appl. No.: 11/863,010

(22) Filed: Sep. 27, 2007

(51) Int. Cl. G06F 9/46; G06F 13/10

(52) U.S. Cl. 718/105; 718/108

(57) ABSTRACT

In general, the invention relates to a system that includes a multi-core processor and a dispatcher operatively connected to the multi-core processor. The dispatcher is configured to receive a first plurality of threads during a first period of time, dispatch the first plurality of threads only to a first core of the plurality of cores, receive a second plurality of threads during a second period of time, dispatch the second plurality of threads only to a second core of the plurality of cores, migrate to the second core any of the first plurality of threads that are still executing on the first after the first period of time has elapsed. The duration of the first period of time and the duration of the second period of time are determined using a thread migration schedule, and thread migration schedule is determined using at least one thermal characteristic of the multi-core processor.

### BACKGROUND

A modem computer system may be divided roughly into three conceptual elements: the hardware, the operating system, and the application programs. The hardware, e.g., the central processing unit (CPU), the memory, the persistent storage devices, and the input/output devices, provides the basic computing resources. The application programs, such as compilers, database systems, software, and business programs, define the ways in which these resources are used to solve the computing problems of the users. The users may include people, machines, and other computers that use the application programs, which in turn employ the hardware to solve numerous types of problems.

An operating system (“OS”) is a program that acts as an intermediary between a user of a computer system and the computer hardware. The purpose of an operating system is to provide an environment in which a user can execute application programs in a convenient and efficient manner. A computer system has many resources (hardware and software) that may be required to solve a problem, e.g., central processing unit (“CPU”) time, memory space, file storage space, input/output (“I/O”) devices, etc. The operating system acts as a manager of these resources and allocates them to specific programs and users as necessary.

Because there may be many, possibly conflicting, requests for resources, the operating system must decide which requests are allocated resources to operate the computer system efficiently and fairly.

Moreover, an operating system may be characterized as a control program.

The control program controls the execution of user programs to prevent errors and improper use of the computer. It is especially concerned with the operation of I/O devices. In general, operating systems exist because they are a reasonable way to solve the problem of creating a usable computing system. The fundamental goal of a computer system is to execute user programs and make solving user problems easier. Toward this goal, computer hardware is constructed. Because bare hardware alone is not particularly easy to use, application programs are developed. These various programs require certain common operations, such as those controlling the I/O operations. The common functions of controlling and allocating resources are then brought together into one piece of software: the operating system.

In order to conserve energy, some computer systems incorporate power control mechanisms. For example, Energy Star (“E*”) power requirements require system power consumption to be lowered to 15% of the normal operating power consumption level when the system is idle. In order to conserve power, the operating system turns off (or lowers the operating frequencies of) inactive devices, such as hard disks and monitors. The operating system may also conserve power by adjusting the execution of the CPU.

A common method of conserving power is to coalesce threads to a subset of system resources, such as to a particular core within a multi-core processor. While coalescing threads to a single core within the multi-core processor can allow for decreased power consumption of the remaining cores within the multi-core processor, the coalescing results in an asymmetrical thermal profile for the multi-core processor. In particular, the core executing the threads heats up (as a result of the execution) while the other inactive cores remain relatively cool. The increased temperature of the core executing the threads increases leakage current. As load fluctuates, the asymmetrical thermal profile may induce thermal cycling of the cores on the multi-core processor. The increased leakage current and the thermal cycling damages the multi-core processor and, in turn, reduces the reliability of the multi-core processor.

### SUMMARY

In general, in one aspect, the invention relates to a system. The system includes a multi-core processor comprising a plurality of cores and a dispatcher operatively connected to the multi-core processor. The dispatcher is configured to receive a first plurality of threads during a first period of time, dispatch the first plurality of threads only to a first core of the plurality of cores, receive a second plurality of threads during a second period of time, dispatch the second plurality of threads only to a second core of the plurality of cores, migrate to the second core any of the first plurality of threads that are still executing on the first after the first period of time has elapsed, wherein a duration of the first period of time and a duration of the second period of time are determined using a thread migration schedule, and wherein the thread migration schedule is determined using at least one thermal characteristic of the multi-core processor,

In general, in one aspect, the invention relates to a system. The system includes a multi-core processor that includes a first core, a second core, a third core, and a fourth core, and a first cache and a second cache, wherein the first core and the second core share the first cache, and wherein the third core and the fourth core share the second cache. The system further includes a dispatcher operatively connected to the multi-core processor and configured to receive a first plurality of threads during a first period of time, dispatch a first portion of the first plurality of threads only to the first core, dispatch a second portion of the first plurality of threads only to the third core, receive a second plurality of threads during a second period of time, dispatch a first portion of the second plurality of threads only to the second core, dispatch a second portion of the second plurality of threads only to the fourth core, migrate, during the second period of time, from the first core to the second core any of the first portion of the first plurality of threads that are still executing on the first core after the first period of time has elapsed, and migrate, during the second period of time, from the third core to the fourth core any of the second portion of the first plurality of threads are still executing on the third core after the first period of time has elapsed, wherein a duration of the first period of time and a duration of the second period of time are determined using a thread migration schedule, and wherein the thread migration schedule is determined using at least one thermal characteristic of the multi-core processor.

In general, in one aspect, the invention relates to a method for dispatching threads. The method includes receiving a first plurality of threads during a first period of time, dispatching the first plurality of threads only to a first core of the plurality of cores in a multi-core processor, receiving a second plurality of threads during a second period of time, dispatching the second plurality of threads only to a second core of the plurality of cores in the multi-core processor, and migrating to the second core any of the first plurality of threads that are still executing on the first core after the first period of time has elapsed, wherein a duration of the first period of time and a duration of the second period of time are determined using a thread migration schedule, and wherein the thread migration schedule is determined using at least one thermal characteristic of the multi-core processor.

Other aspects of the invention will be apparent from the following description and the appended claims.

### BRIEF DESCRIPTION OF DRAWINGS

FIG. 1 shows a system in accordance with one embodiment of the invention.

FIG. 2 shows a system in accordance with one embodiment of the invention.

FIG. 3 shows a flowchart system in accordance with one embodiment of the invention.

FIGS. 4A-4B show flowcharts in accordance with one embodiment of the invention.

FIGS. 5, 6A-6D, and 7A-7B show examples in accordance with one embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details.

In other instances, well-known features have not been described in detail to avoid unnecessarily complicating the description.

In general, embodiments of the invention relate to a method and system for managing on-chip thermal asymmetries. More specifically, embodiments of the invention provide a method and system for dispatching threads such that on-chip thermal asymmetries are reduced.

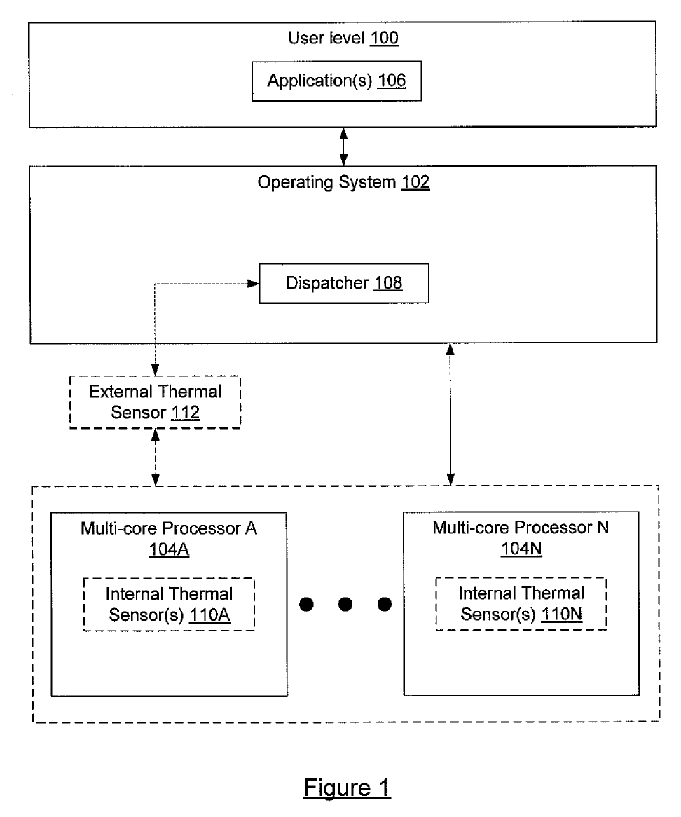

FIG. 1 shows a system in accordance one embodiment of the invention. The system includes a user level (100), an operating system (102), and one or more multi-core processors (104A, 104N). Each of the above components is described below.

In one embodiment of the invention, the user level (100) is the software layer of the system with which the user interacts. In addition, the user level (100) includes one or more applications (106). Examples of applications include, but are not limited to, a web browser, a text processing program, a spreadsheet program, and a multimedia program. The applications (106) executing in the user level (100) require hardware resources of the system (e.g., memory, processing power, persistent storage, etc.). The applications (106) request hardware resources from the operating system (102).

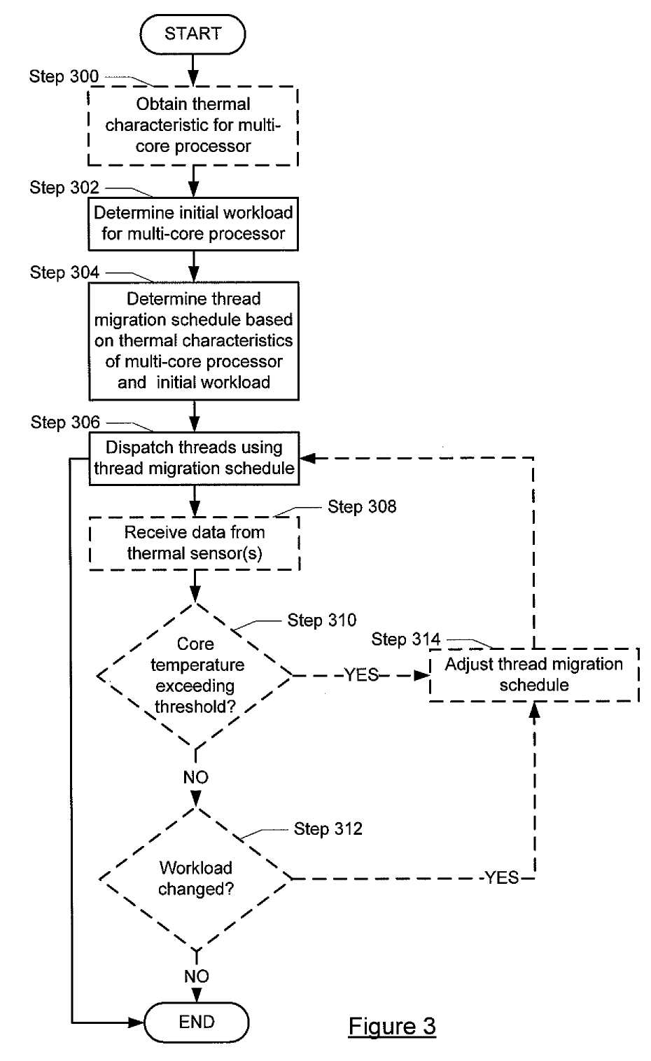

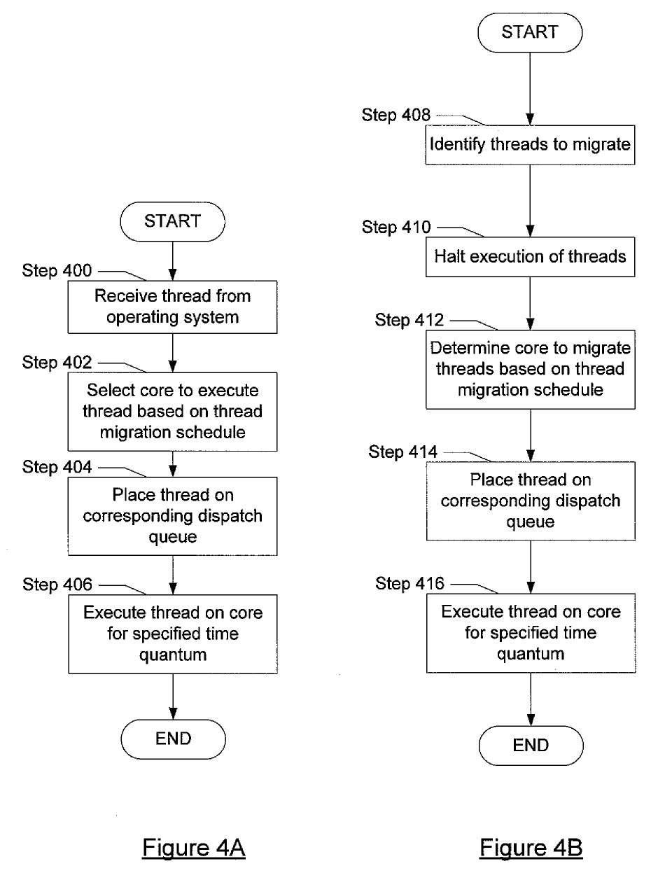

The operating system (102) provides an interface between the user level (106) and the hardware resources. In one embodiment of the invention, applications (106) are executed using threads. In one embodiment of the invention, each thread corresponds to a thread of execution in an application (or in the operating system). Further, threads may execute concurrently in a given application (106) (or in the operating system). The execution of threads is managed by a dispatcher (108). The dispatcher (108) includes functionality to determine which threads are executed by which multi-core processors (104A, 104N) and the order in which the threads are executed (e.g., higher priority threads are placed ahead of lower priority threads). The operation of the dispatcher (108) is discussed below in FIGS. 3 and 4A-4B.

Continuing with the discussion of FIG. 1, the system includes one or more multi-core processors (104A, 104N). The multi-core processors (104A, 104N) may optionally include internal thermal sensors (110A, 110N). Alternatively, the system may include an external thermal sensor(s) (112). The thermal sensor(s) (internal or external) is configured to monitor the temperature of the multi-core processors (104A, 104N). In one embodiment of the invention, the thermal sensor(s) monitors the temperature on a per-core basis for each of the multi-core processors (104A, 104N). The data collected by the thermal sensor(s) is communicated to the dispatcher (108), which may use the information to update the schedule used to dispatch threads to the multi-core processors (104A, 104N).

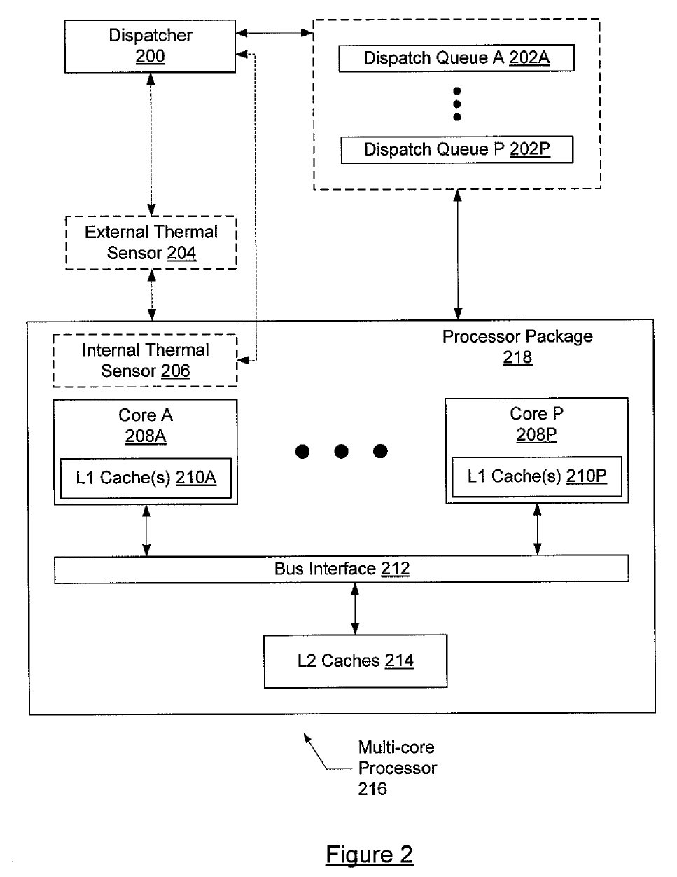

FIG. 2 shows a system in accordance with one embodiment of the invention. More specifically, FIG. 2 shows a multi-core processor (215) in accordance with one or more embodiments of the invention. As shown in FIG. 2, the multi-core processor (215) includes a processor package (218), which serves as the base upon which all of the other components that make up the multi-core processor (215) are mounted. In particular, the multi-core processor (215) includes one or more cores (208A, 208P), where each core (208A, 208P) is a microprocessor. Further, each core (208A, 208P) includes an L1 cache(s) (210A, 210P) (i.e., an on-core cache). Each of the cores (208A, 208P) is operatively connected to at least one other core (208A, 208P) via a bus interface (212). In addition, the bus interface (212) connects the cores (208A, 208P) to other components on the processor package (218), such as the L2 caches (214). As shown in FIG. 2, the cores (208A, 208P) share the L2 cache (214). In one embodiment of the invention, an internal thermal sensor (206) is mounted on the processor package (218). Alternatively, an external thermal sensor (204) is operatively connected to the processor package (218).

In one embodiment of the invention, the dispatcher (200) is configured to assign threads to a given core (208A, 208P) for execution. In one embodiment of the invention, the dispatcher (200) determines the core (208A, 208P) which will execute the thread. Once this determination is made, the dispatcher (200) places the thread on the appropriate dispatch queue (202A, 202P). Those skilled in the art will appreciate that the order of the thread in the appropriate dispatch queue (202A, 202P) is determined using the priority of the thread and one or more well known priority-based thread scheduling algorithms. The cores (208A, 208P) subsequently execute the threads in the order in which they appear on the corresponding dispatch queue (202A, 202P).

In one embodiment of the invention, each core (208A, 208P) may be associated with multiple dispatch queues (202A, 202P), where each of the dispatch queues (202A, 202P) is associated with one logical central processing unit (CPU). In one embodiment of the invention, each core (208A, 208P) may support multiple logical central processing unit (CPU).

As discussed above, one common method for conserving power is to coalesce all threads executing in the system to a core in a multi-core processor. This results in an asymmetrical thermal profile for the multi-core processor. Specifically, the core upon which the coalesced threads are executing is generating heat and, accordingly, is operating at a high temperature. The other cores, which are not executing any threads, are operating at a low temperature. The high temperature not only increases the leakage current for the core but also negatively affects the material which make up the multi-core processor. The negative effect on the materials reduces the reliability and/or lifetime of the multi-core processor.

To address these issues, embodiments of the invention decrease the asymmetrical thermal profile by altering the manner in which threads are dispatched to the various cores in the multi-core processor thereby creating a symmetrical (or nearly symmetrical thermal profile) for the multi-core processor. In addition, embodiments of the invention alter the manner in which threads are dispatched to the various cores in the multi-core processor to ensure that a given core does not exceed a maximum temperature threshold.

FIGS. 3 and 4A-4B show flowcharts of methods in accordance with one or more embodiments of the invention. While the various steps in the flowcharts are presented and described sequentially, one of ordinary skill will appreciate that some or all of the steps may be executed in different orders and some or all of the steps may be executed in parallel.

FIG. 3 shows a flowchart system in accordance with one embodiment of the invention. More specifically, FIG. 3 describes the initialization and operation of the dispatcher in accordance with one embodiment of the invention.

In Step 300, thermal characteristics for the multi-core processor are optionally obtained. In one embodiment, the thermal characteristics may include, but are not limited to, heat generated per core per unit of time while the core is executing threads, heat generated per core per unit of time while the core is idle, on-package cooling mechanisms and the rate at which the on-package cooling mechanisms dissipate the generated heat, and the maximum operating temperature of the core (or multi-core processor).

In Step 302, the initial workload of the multi-core processor is determined.

The initial workload may be anticipated workload based on historical usage of the multi-core processor. Alternatively, the initial workload may be a default workload.

In Step 304, the thread migration schedule is determined using the initial workload and at least one thermal characteristic of the multi-core processor.

Alternatively, a default thermal constant may be used in place of the at least one thermal characteristic of the multi-core processor. For example, the default thermal constant may correspond to a default thermal characteristic of the multi-core processor or a maximum operating temperature of the multi-core processor.

In addition, the thread migration schedule may take into account the off-chip cooling mechanisms in the system in which the multi-processor core is located.

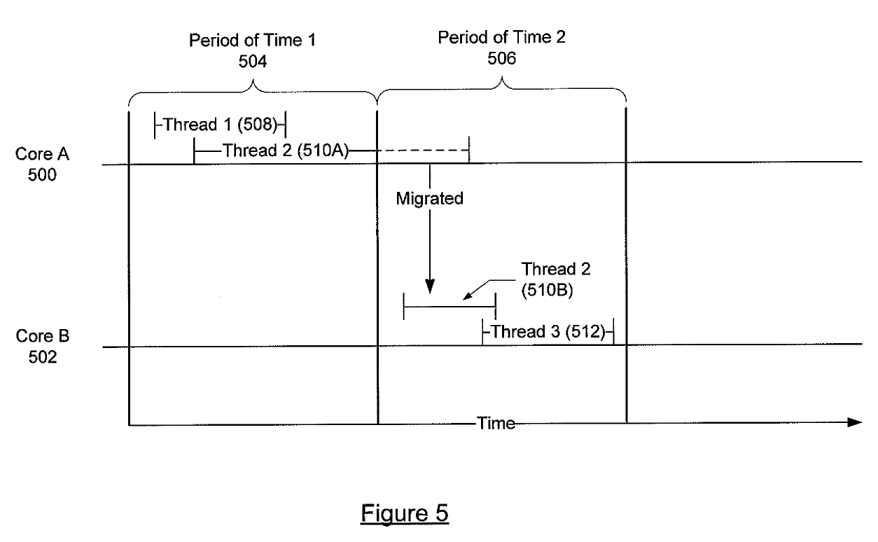

The thread migration schedule is set such that at any given period of time only one core is executing all of the threads (or a subset of the cores are executing all of the threads) while the other cores remain idle. However, in order to maintain thermal symmetry (or near-thermal symmetry) across a given multi-core processor the threads are migrated between the cores (see e.g., FIGS. 5, 6A-6D, 7A-7B).

The rate at which the threads are migrated between the cores is a function to thermal characteristics of the multi-core processor (and optionally, off-chip cooling mechanisms). In particular, the rate at which threads are migrated between the cores is set such that the maximum temperature of a given core does not exceed the maximum operating temperature. Further, in order to maintain thermal symmetry (or near-thermal symmetry) of the multi-core processor, the rate at which the threads are migrated takes into account the rate at which the cores increases in temperature (e.g., as a result of executing threads in view of on-chip and off-chip cooling mechanisms) and the rate at which the core decreases in temperature (e.g., as a result of being idle or being cooled by on-chip and off-chip cooling mechanisms). Finally, the rate at which the threads are migrated may depend on the performance impact of migrating threads. The performance impact may be caused by the invalidation of L1 and L2 caches as well as the overhead in the operating system for re-dispatching threads to another core. In view of the above, the thread migration schedule defines which core of the multi-core processor is executing threads at a given time.

In Step 306, threads are dispatched using the thread migration schedule. Dispatching threads covers two cases. The first case, described in FIG. 4A, addresses the dispatching of new threads received by the dispatcher. The second case, described in FIG. 4B, addresses the migration of threads from one core to another. At this stage the process ends.

Alternatively, if the system supports a feedback mechanism, then Steps 308-314 may be performed. In Step 308, data is received from the thermal sensor(s) (internal and/or external). The data may include, but is not limited to, temperature of the individual cores in the multi-core processor.

In Step 310, a determination is made about whether the core temperature exceeds threshold (e.g., maximum operating temperature or another temperature, which is less than the maximum operating temperature). If the core temperature exceeds threshold, then the process proceeds to Step 314 in which the thread migration schedule is adjusted to decrease the core temperature.

If the core temperature does not exceed the threshold, the process may still proceed to Step 314 if the data from the thermal sensor(s) indicates that there is thermal asymmetry in the multi-core processor. In one embodiment of the invention, there is thermal asymmetry in the multi-core processor when the temperatures of at least two cores within the multi-core processor are not substantially similar. The exact difference in temperature which results in thermal asymmetry may be determined on a per-multi-core processor basis.

Continuing with the discussion of FIG. 3, if the core temperature does not exceed the threshold, in Step 312 a determination is made about whether the workload for the core (or multi-processor) has changed. If the workload has changed, the thread migration schedule may be adjusted in anticipation of higher operating temperatures of the multi-processor or adjusted in anticipation of lower workload thereby decreasing the rate at which threads are migrated (Step 314). Alternatively, no action may taken.

FIG. 4A shows a flowchart in accordance one embodiment of the invention. More specifically, FIG. 4A shows a flowchart for dispatching newly received threads in accordance one embodiment of the invention.

In Step 400, a thread is received from the operating system. Those skilled in the art will appreciate that the thread may have originated from the user level or the operating system. In Step 402, the core upon which the thread is to be executed is selected using the thread migration schedule. In Step 404, the thread is placed on the corresponding dispatch queue (i.e., a dispatch queue associated with the selected core). In Step 406, the thread is executed on the core for a specified them quantum.

FIG. 4B shows a flowchart in accordance one embodiment of the invention. More specifically, FIG. 4B shows a flowchart for migrating threads in accordance one embodiment of the invention. In Step 408, the threads to migrate are determined. In one embodiment of the invention, the threads to migrate correspond to any thread executing on a core at the time that the core is supposed to idle (i.e., another core is to be used to execute threads per the thread migration schedule).

In Step 410, the execution of the threads identified in Step 408 is halted. In Step 412, the core upon which the threads are to be migrated is determined using the thread migration schedule. In Step 414, the threads are placed on the corresponding dispatch queue (i.e., a dispatch queue associated with the selected core). In Step 416, the threads are executed (or the execution of the threads is continued) on the core for a specified time quantum.

FIGS. 5, 6A-6D, and 7A-7B show examples in accordance one embodiment of the invention. The following examples are not intended to limit the scope of the invention.

FIG. 5 shows an example of the dispatcher in accordance with the methods disclosed in FIGS. 3 and 4A-4B. Turning to FIG. 5, consider the scenario in which the multi-core processor includes two cores: core A (500) and core B (502). Further, the thread migration schedule dictates that all threads are to be executed on core A (500) for period of time 1 (504) and all threads are to be executed on core B (502) for period of time 2 (506). As discussed above, the duration of the period of time (504, 506) as well as the order in which cores are used to execute threads is specified by the thread migration schedule.

As shown in FIG. 5, during period of time 1 (504) thread 1 (508) and thread 2 (510A) are received and dispatched to core A (500). During period of time 1 (504), thread 1 (508) completes executing while thread 2 (510A) does not.

Thus, at the expiration of period of time 1 (504), thread 2 (510A) must be migrated to core B (502) in accordance with the thread migration schedule. Thus, the execution of thread 2 (510A) is halted on core A (500), migrated to core B (502) and then re-started on core B (502). Migrated thread 2 (510B) then completes execution on core B (502). In addition, during period of time 2 (506), thread 3 (512) is received and dispatched to core B (502). During period of time 2 (506), thread 3 (512) completes executing.

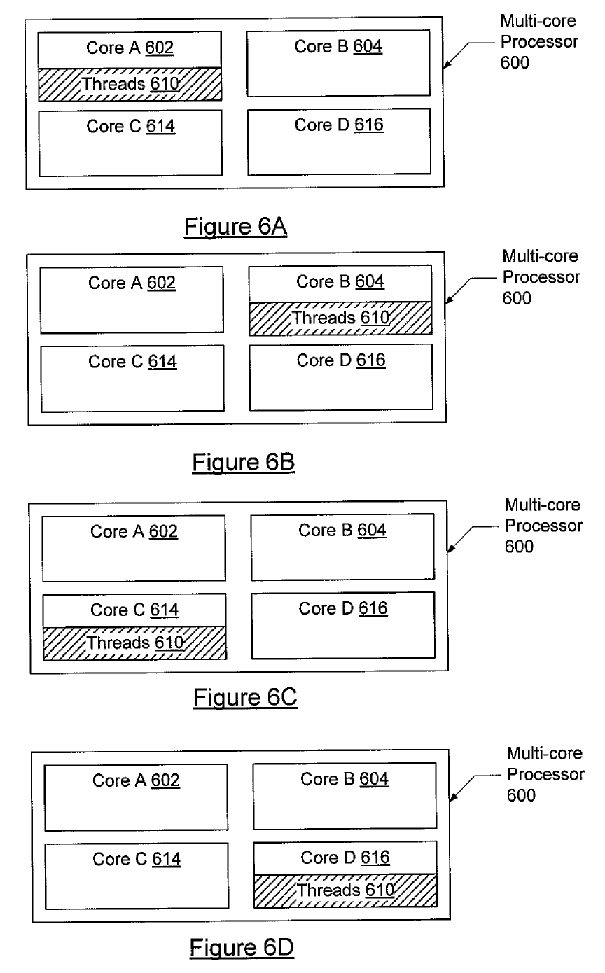

FIGS. 6A-6D show a graphical representation of an example implementation of a thread migration schedule in accordance with one embodiment of the invention. As discussed above, the thread migration schedule defines the rate of migration as well as the order in which the threads are migrated through the cores. Consider the scenario in which the multi-core processor (600) includes the following cores: core A (602), core B (604), core C (606), and core D (608). Further, the thread migration schedule indicates that the threads (612) are migrated in the following order: core A (602) to core B (604), core B (604) to core C (606), core C (606) to core D (608), and core D (608) to core A (602). FIG. 6A shows the initial execution of the threads (612) on core A (602). FIG. 6B shows the execution of the threads (612) on core B (604) after migration from core A (602) to core B (604). FIG. 6C shows the execution of the threads (612) on core C (606) after migration from core B (604) to core C (606). FIG. 6D shows the execution of the threads (612) on core D (608) after migration from core C (606) to core D (608). Those skilled in the art will appreciate that the threads (612) shown in FIGS. 6A-6D include migrated threads as well as newly received threads. The manner of thread migration shown in FIGS. 6A-6D may be referred to as Rotisserie migration.

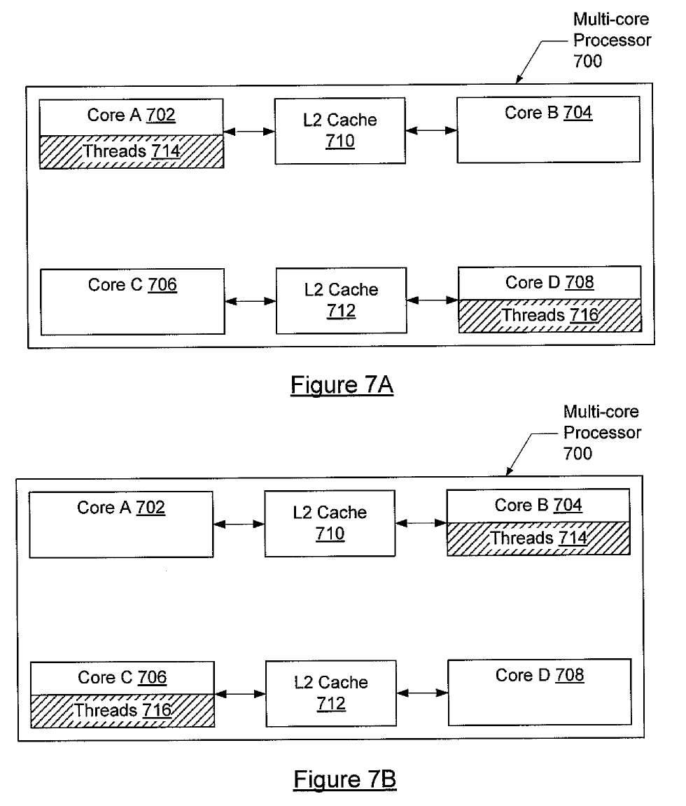

FIGS. 7A-7B show a graphical representation of an example implementation of a thread migration schedule in accordance with one embodiment of the invention. As discussed above, the thread migration schedule defines the rate of migration as well as the order in which the threads are migrated through the cores. Consider the scenario in which the multi-core processor (700) includes the following cores: core A (702), core B (704), core C (706), and core D (708).

The thread migration schedule indicates that the threads (612) are migrated in the following order: core A (702) to core B (704) and core D (708) to core C (706). In addition, the thread migration schedule indicates that core A (702) and core D (708) operate simultaneously, while core B (704) and core C (706) remain idle. When the threads (714, 716) are to be migrated, the threads (714, 716) are migrated from core A (702) to core B (704) and core D (708) to core C (706). At that time, core A (702) and core D (708) are set to an idle state.

The above thread migration schedule takes into account the performance benefit of migrating threads between cores that share a common cache (710, 712).

In this case, core A (702) and core B (704) share L2 cache (710) and core D (708) to core C (706) share L2 cache (712). Thus, when the threads (714, 716) are migrated, the cache entries in the shared caches (710, 712) are not invalidated.

FIG. 7A shows the initial execution of the threads (714, 716) on core A (702) and core D (708). FIG. 7B shows the execution of the threads (714, 716) on core B (704) and core C (706) after migration from A (702) and core D (708).

Those skilled in the art will appreciate that the threads (714, 716) shown in FIGS. 7A-7B include migrated threads as well as newly received threads.

Those skilled in the art will appreciate that in some instances, the performance degradation resulting from the migration of threads between cores outweighs the power conservation by only using a single core (or subset of cores) in the multi-core processor. In such cases, the operating system may spawn new processes and the dispatcher may dispatch the new processes to other cores on the multi-core processor. In this scenario, the execution of new processes on other cores results in a symmetric thermal profile across the multi-core processor.

One or more embodiments of the invention may be extended to migrating threads between multi-core processors on a single system board in order to reduce thermal asymmetry across the system board.

Those skilled in the art will appreciate that embodiments of the invention may be utilized on a core is capable of simultaneously executing multiple threads of execution, as might be implemented by Symmetric Multi-Threaded core architecture (SMT), a Vertically threaded core architecture, or other multi-threaded core architecture. Further, embodiments of the invention may be applied to any processor architecture where multiple threads can be executed simultaneously, and the number of threads executing is less than the processor's capacity, and where migrating the load would result in a more symmetric thermal distribution of heat, and where migrating occurs often enough to prevent thermal cycling.

The invention (or portions thereof), may be implemented on virtually any type of computer regardless of the platform being used. For example, the computer system may include a processor, associated memory, a storage device, and numerous other elements and functionalities typical of today's computers (not shown). The computer may also include input means, such as a keyboard and a mouse, and output means, such as a monitor. The computer system is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system may be located at a remote location and connected to the other elements over a network. Further, the invention may be implemented on a distributed system having a plurality of nodes, where each portion of the invention (e.g., dispatcher, multi-core processor) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system comprising:
a multi-core processor comprising a plurality of cores;
a dispatcher operatively connected to the multi-core processor and configured to:
receive a first plurality of threads during a first period of time;
dispatch the first plurality of threads only to a first core of the plurality of cores;
receive a second plurality of threads during a second period of time;
dispatch the second plurality of threads only to a second core of the plurality of cores,
migrate to the second core any of the first plurality of threads that are still executing on the first after the first period of time has elapsed;
wherein a duration of the first period of time and a duration of the second period of time are determined using a thread migration schedule, and
wherein the thread migration schedule is determined using at least one thermal characteristic of the multi-core processor.

2. The system of claim 1, further comprising:
a thermal sensor configured to monitor a temperature of the multi-core processor,
wherein data from the thermal sensor is used to determine the thread migration schedule.

3. The system of claim 1, wherein the at least one thermal characteristic is a heat dissipation schedule of the multi-core processor.

4. The system of claim 1, wherein the thread migration schedule is further determined using an anticipated workload of the multi-core processor.

5. The system of claim 1, wherein the thread migration schedule is set to maintain a first temperature in the first core and a second temperature in the second core, wherein the first temperature and the second temperature are substantially similar.

6. The system of claim 5, wherein the first temperature and the second temperature are below a threshold temperature of the multi-core processor.

7. A system comprising:
a multi-core processor comprising:
a first core, a second core, a third core, and a fourth core, and
a first cache and a second cache,
wherein the first core and the second core share the first cache, and
wherein the third core and the fourth core share the second cache; and
a dispatcher operatively connected to the multi-core processor and configured to:
receive a first plurality of threads during a first period of time;
dispatch a first portion of the first plurality of threads only to the first core;
dispatch a second portion of the first plurality of threads only to the third core;
receive a second plurality of threads during a second period of time;
dispatch a first portion of the second plurality of threads only to the second core;
dispatch a second portion of the second plurality of threads only to the fourth core;
migrate, during the second period of time, from the first core to the second core any of the first portion of the first plurality of threads that are still executing on the first core after the first period of time has elapsed; and
migrate, during the second period of time, from the third core to the fourth core any of the second portion of the first plurality of threads are still executing on the third core after the first period of time has elapsed,
wherein a duration of the first period of time and a duration of the second period of time are determined using a thread migration schedule, and
wherein the thread migration schedule is determined using at least one thermal characteristic of the multi-core processor.

8. The system of claim 7, further comprising:
a thermal sensor configured to monitor a temperature of the multi-core processor,
wherein data from the thermal sensor is used to determine the thread migration schedule.

9. The system of claim 7, wherein the at least one thermal characteristic is a heat dissipation schedule of the multi-core processor.

10. The system of claim 7, wherein the thread migration schedule is further determined using an anticipated workload of the multi-core processor.

11. The system of claim 7, wherein the thread migration schedule is set to maintain a first temperature in the first core and a second temperature in the second core, wherein the first temperature and the second temperature are substantially similar.

12. The system of claim 11, wherein the first temperature and the second temperature are below a threshold temperature of the multi-core processor.

13. A method for dispatching threads, comprising:
receiving a first plurality of threads during a first period of time;
dispatching the first plurality of threads only to a first core of the plurality of cores in a multi-core processor;
receiving a second plurality of threads during a second period of time;
dispatching the second plurality of threads only to a second core of the plurality of cores in the multi-core processor; and
migrating to the second core any of the first plurality of threads that are still executing on the first core after the first period of time has elapsed,
wherein a duration of the first period of time and a duration of the second period of time are determined using a thread migration schedule, and
wherein the thread migration schedule is determined using at least one thermal characteristic of the multi-core processor.

14. The method of claim 13, further comprising:
obtaining data from a thermal sensor configured to monitor a temperature of the multi-core processor,
wherein the data from the thermal sensor is used to determine the thread migration schedule.

15. The method of claim 13, wherein the at least one thermal characteristic is a heat dissipation schedule of the multi-core processor.

16. The method of claim 13, wherein the thread migration schedule is further determined using an anticipated workload of the multi-core processor.

17. The method of claim 13, wherein the thread migration schedule is set to maintain a first temperature in the first core and a second temperature in the second core, wherein the first temperature and the second temperature are substantially similar.

18. The method of claim 17, wherein the first temperature and the second temperature are below a threshold temperature of the multi-core processor.
